(19) United States
(12) Patent Application Publication
(10) Pub. No.: US 2024/0048935 A1
(43) Pub. Date: Feb. 8, 2024

(54) Apparatus, Methods and Computer Programs for Providing Spatial Audio

(71) Applicant: Nokia Technologies Oy, Espoo (FI)

(72) Inventors: Jussi Kalevi Virolainen, Espoo (FI); Juha Taplo VILKAMO, Helsinki (FI); Mikko-Ville LAITINEN, Espoo (FI)

(21) Appl. No.: 18/265,473

(22) PCT Filed: Nov. 18, 2021
(86) PCT No.: PCT/FI2021/050781

§ 371 Date: Jun. 6, 2023

(30) Foreign Application Priority Data
Dec. 11, 2020 (GB) 2019567.3

(51) Int. Cl. H04S 7/00

(52) U.S. Cl. CPC H04S 7/304; H04S 7/308; H04S 2400/15

(57) ABSTRACT

Examples of the disclosure could be implemented in systems where a first device, such as a mobile phone or other processing device, renders audio input signals to provide spatial audio. The spatial audio can then be transmitted to another device, such as a headset or earphones for playback. In such examples the rendering apparatus is configured to receive one or more audio input signals and information indicative of a user head position. The rendering apparatus processes the received one or more audio input signals to obtain a spatial audio signal based on the user head position and obtains compensation metadata. The compensation metadata includes information indicating how the spatial audio signal should be adjusted to account for a change in the user head position. The rendering apparatus includes the compensation metadata to be used to adjust the spatial audio signal to account for a change in the user head position.

### TECHNOLOGICAL FIELD

Examples of the disclosure relate to apparatus, methods and computer programs for providing spatial audio. Some relate to apparatus, methods and computer programs for providing spatial audio where the spatial audio can be played back via a headset or earphones.

### BACKGROUND

Head mounted playback devices such as headsets or earphones can be used to playback spatial audio to a user. The spatial audio can be rendered to correspond to the user's head position so that the spatial aspects of the spatial audio correspond to the user's head position. If there is an inaccuracy in the alignment between the user's head position and the spatial audio this could be perceived by the user.

### BRIEF SUMMARY

According to various, but not necessarily all, examples of the disclosure there is provided a rendering apparatus comprising means for: receiving one or more audio input signals; receiving information indicative of a user head position; processing the received one or more audio input signals to obtain a spatial audio signal based on the user head position; obtaining compensation metadata wherein the compensation metadata comprises information indicating how the spatial audio signal should be adjusted to account for a change in the user head position; and enabling the compensation metadata to be used to adjust the spatial audio signal to account for a change in the user head position.

The compensation metadata may comprise information indicating the user head position on which the spatial audio signal is based.

The rendering apparatus may comprise means for enabling the compensation metadata to be transmitted with the spatial audio signal for playback by a playback apparatus.

The spatial audio signal may comprise a binaural signal.

The compensation metadata may comprise information indicating how one or more spatial features of the spatial audio signals are to be adjusted to account for a difference in the user head position compared to the user head position on which the spatial audio signal is based.

The compensation metadata comprises instructions to a playback apparatus to enable the adjustments to the spatial audio to be performed by the playback apparatus.

The adjustments to the spatial audio signal that are enabled by the compensation metadata may require fewer computational resources than the processing of the audio input signals to provide the spatial audio signal.

The adjustments to the spatial audio signal may enable a lag in processing of the audio signals and/or transmission of the audio signals to be accounted for.

The adjustments to the spatial audio signal may enable an error in a predicted head position to be accounted for.

The adjustments to the spatial audio signal may enable minor corrections to be made to the spatial audio signal.

According to various, but not necessarily all, examples of the disclosure there is provided a method comprising: receiving one or more audio input signals; receiving information indicative of a user head position; processing the received one or more audio input signals to obtain a spatial audio signal based on the user head position; obtaining compensation metadata wherein the compensation metadata comprises information indicating how the spatial audio signal should be adjusted to account for a change in the user head position; and enabling the compensation metadata to be used to adjust the spatial audio signal to account for a change in the user head position.

According to various, but not necessarily all, examples of the disclosure there is provided a computer program comprising computer program instructions that, when executed by processing circuitry, cause: receiving one or more audio input signals; receiving information indicative of a user head position; processing the received one or more audio input signals to obtain a spatial audio signal based on the user head position; obtaining compensation metadata wherein the compensation metadata comprises information indicating how the spatial audio signal should be adjusted to account for a change in the user head position; and enabling the compensation metadata to be used to adjust the spatial audio signal to account for a change in the user head position.

According to various, but not necessarily all, examples of the disclosure there is provided a rendering apparatus comprising at least one processor; and at least one memory including computer program code, the at least one memory and the computer program code configured to, with the at least one processor, cause the rendering apparatus at least to perform: receiving one or more audio input signals; receiving information indicative of a user head position; processing the received one or more audio input signals to obtain a spatial audio signal based on the user head position; obtaining compensation metadata wherein the compensation metadata comprises information indicating how the spatial audio signal should be adjusted to account for a change in the user head position; and enabling the compensation metadata to be used to adjust the spatial audio signal to account for a change in the user head position.

According to various, but not necessarily all, examples of the disclosure there is provided a playback apparatus comprising means for: receiving spatial audio signals and compensation metadata wherein the spatial audio signals are processed based on an indicated user head position and the compensation metadata comprises information indicating how the spatial audio signal should be adjusted to account for a change in the user head position; determining a current user head position; and using the compensation metadata to adjust the spatial audio to the determined current head position if the current user head position is different to the user head position on which the spatial audio signals are based.

The compensation metadata may comprise information indicating the user head position on which the spatial audio signal is based.

The spatial audio signal may comprise a binaural signal.

The spatial audio signal may be obtained from a rendering apparatus configured to process audio input signals to obtain the spatial audio signal.

The playback apparatus may comprise one or more sensors configured to determine the user head position.

The playback apparatus may comprise means for providing information indicative of a user head position to a rendering device.

The user head position may comprise an angular orientation of the user's head and/or a location of the user.

According to various, but not necessarily all, examples of the disclosure there may be provided a method comprising: receiving spatial audio signals and compensation metadata wherein the spatial audio signals are processed based on an indicated user head position and the compensation metadata comprises information indicating how the spatial audio signal should be adjusted to account for a change in the user head position; determining a current user head position; and using the compensation metadata to adjust the spatial audio to the determined current head position if the current user head position is different to the user head position on which the spatial audio signals are based.

According to various, but not necessarily all, examples of the disclosure there may be provided a computer program comprising computer program instructions that, when executed by processing circuitry, cause: receiving spatial audio signals and compensation metadata wherein the spatial audio signals are processed based on an indicated user head position and the compensation metadata comprises information indicating how the spatial audio signal should be adjusted to account for a change in the user head position; determining a current user head position; and using the compensation metadata to adjust the spatial audio to the determined current head position if the current user head position is different to the user head position on which the spatial audio signals are based.

According to various, but not necessarily all, examples of the disclosure there is provided a playback apparatus comprising at least one processor; and at least one memory including computer program code, the at least one memory and the computer program code configured to, with the at least one processor, cause the playback apparatus at least to perform: receiving spatial audio signals and compensation metadata wherein the spatial audio signals are processed based on an indicated user head position and the compensation metadata comprises information indicating how the spatial audio signal should be adjusted to account for a change in the user head position; determining a current user head position; and using the compensation metadata to adjust the spatial audio to the determined current head position if the current user head position is different to the user head position on which the spatial audio signals are based.

### BRIEF DESCRIPTION

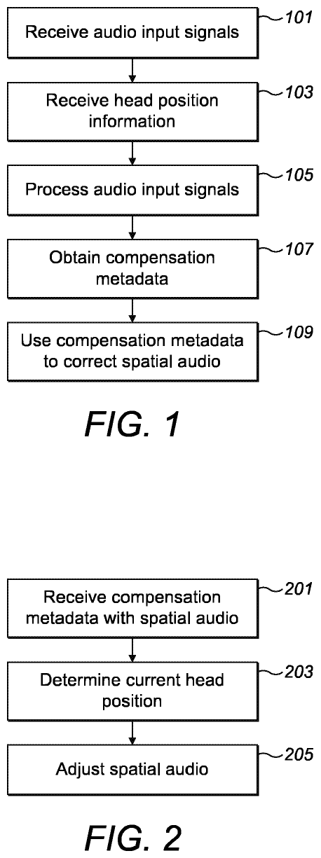

FIG. 1 shows an example method;

FIG. 2 shows another example method;

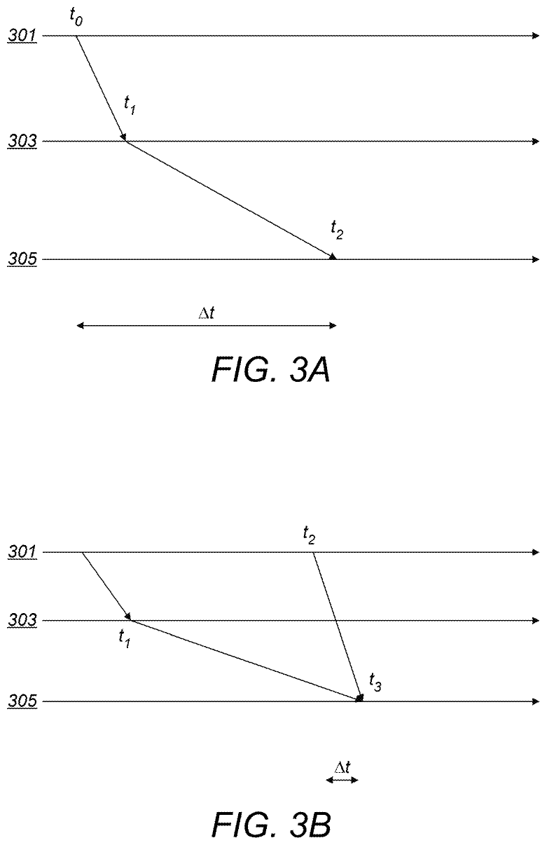

FIGS. 3A and 3B show the timing of the transmission of signals;

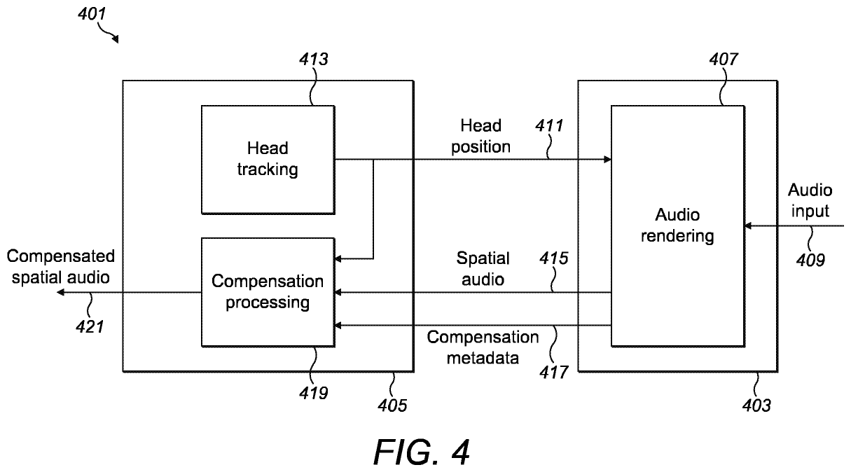

FIG. 4 shows a system according to examples of the disclosure;

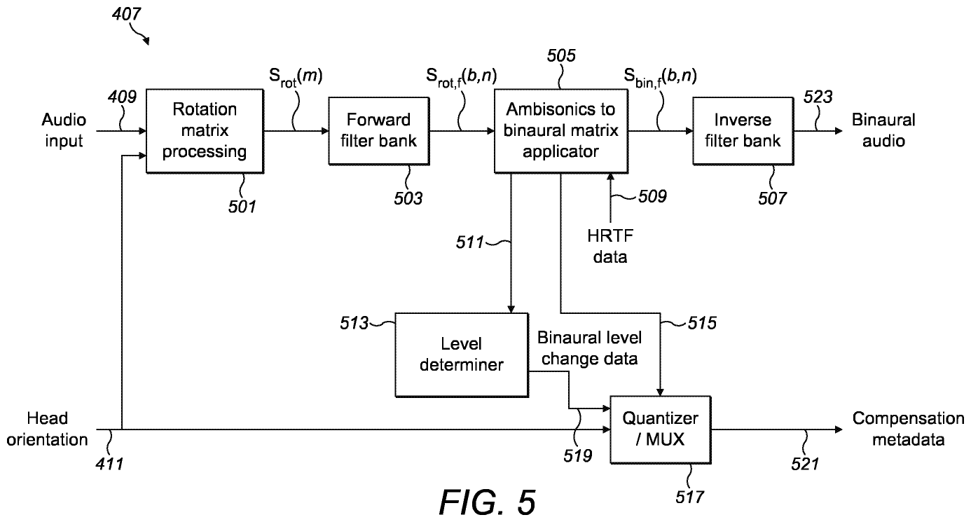

FIG. 5 shows an audio rendering module of a system;

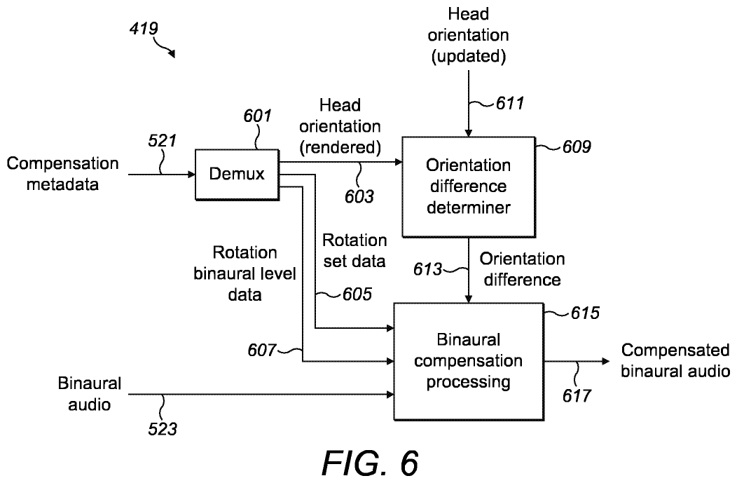

FIG. 6 shows a compensating module of a system;

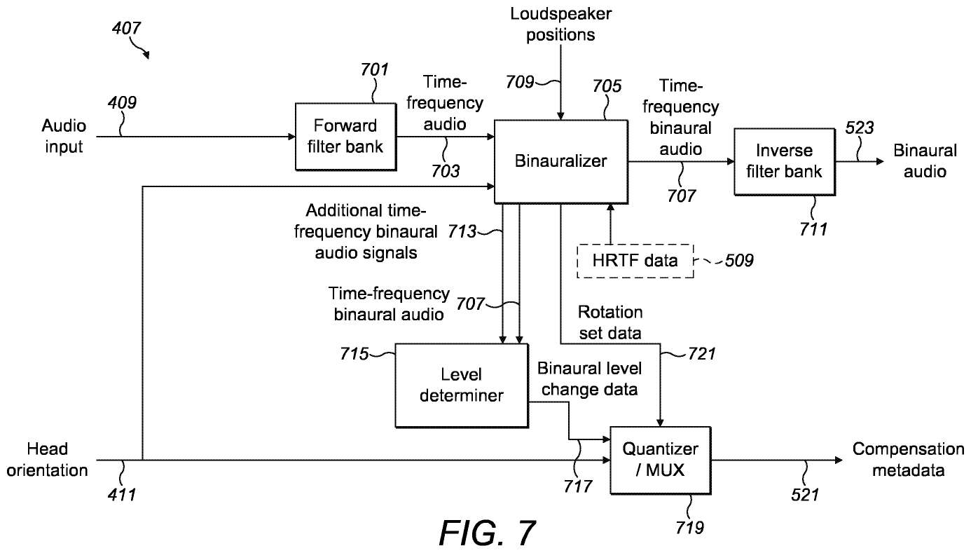

FIG. 7 shows another audio rendering module of a system;

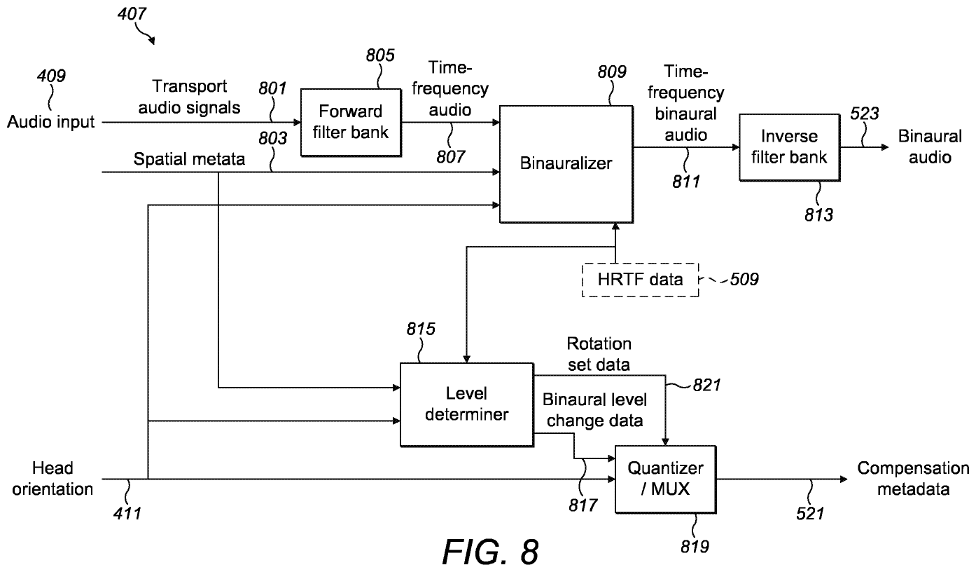

FIG. 8 shows another audio rendering module of a system;

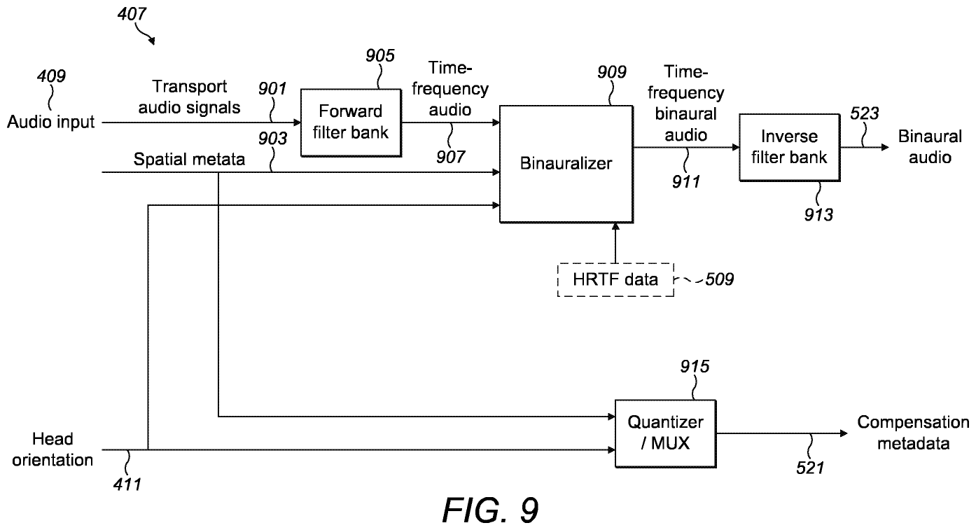

FIG. 9 shows another audio rendering module of a system;

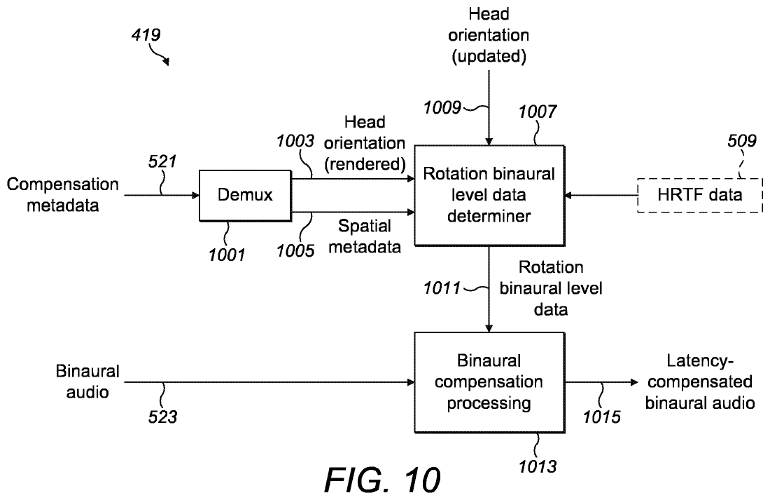

FIG. 10 shows another compensating module of a system;

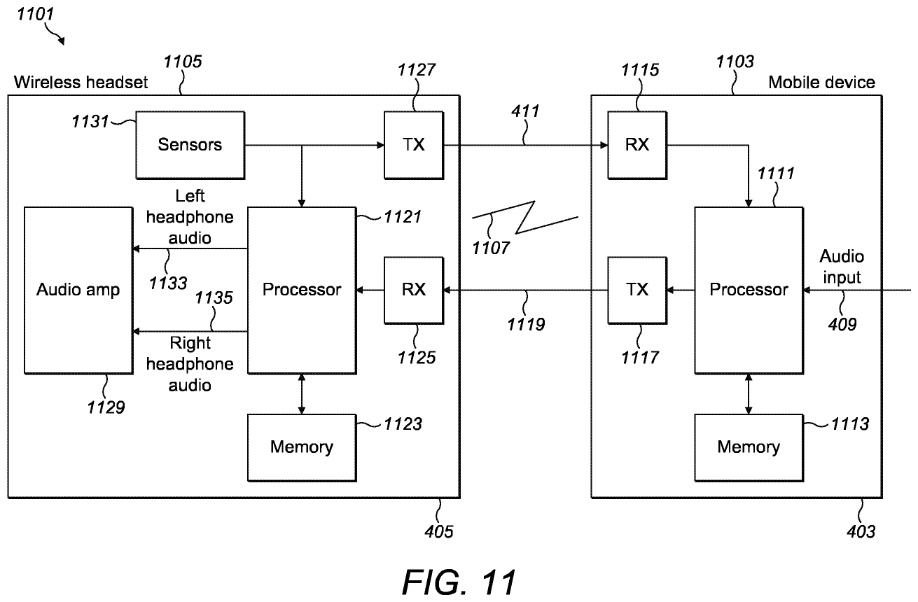

FIG. 11 shows a system according to examples of the disclosure;

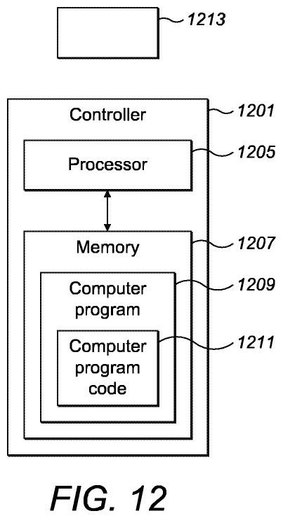

FIG. 12 shows an apparatus; and

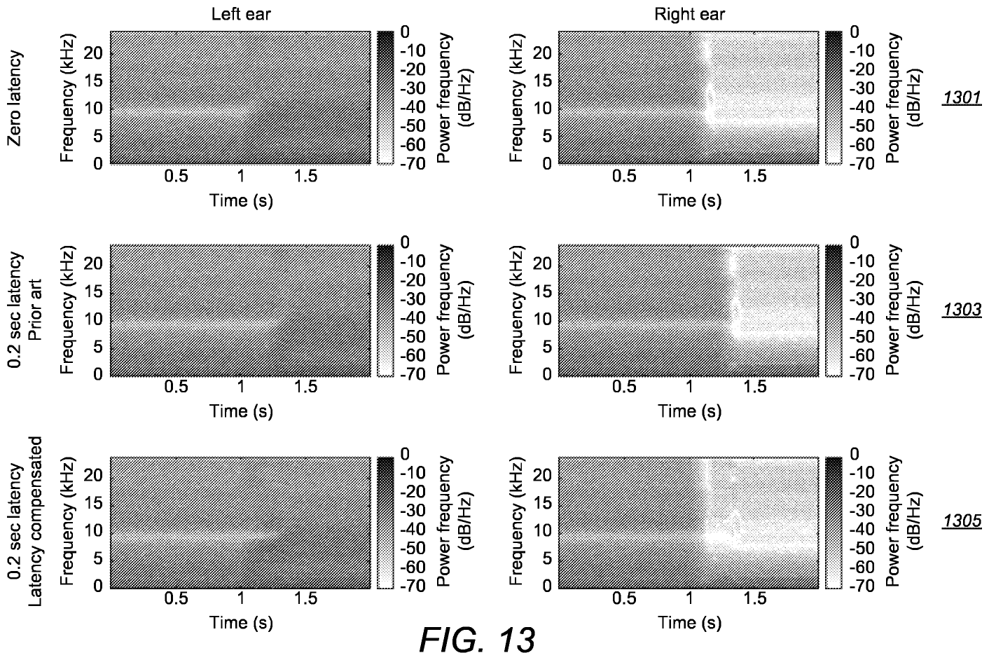

FIG. 13 shows example outputs of a system.

### DETAILED DESCRIPTION

Examples of the disclosure could be implemented in systems where a first device, such as a mobile phone or other processing device, renders audio input signals to provide spatial audio. The spatial audio can then be transmitted to another device, such as a headset or earphones for playback. The exchange of the audio signals between the rendering device and the playback device can cause latency issues, or other problems, that can cause perceivable errors in the rendering and playback of spatial audio. Examples of the disclosure are configured to correct or reduce such errors.

FIG. 1 shows a method according to examples of the disclosure. The method of FIG. 1 could be performed by a rendering apparatus. The rendering apparatus could be a mobile phone or other suitable type of user device. The rendering apparatus could be any processing device that can be configured to render spatial audio from audio input signals.

The method comprises, at block 101, receiving one or more audio input signals.

The audio input signals can comprise any signals in a format that allows spatial audio reproduction. For example, the audio input signals could comprise mono audio, stereo audio, multichannel audio, audio objects (audio channels with spatialization metadata such as directions, locations, object size), parametric audio signals (one or more audio channels with associated spatial metadata in frequency bands such as an IVAS MASA format audio stream), Ambisonics audio, and/or any combination of such audio input signals.

The audio input signals can be received from any suitable source. They could be received via a communications network such as a cellular communications network, internet or any other suitable communication network. In some examples the audio input signals can be stored in a memory of the rendering apparatus and retrieved as needed.

At block 103 the method comprises receiving information indicative of a user head position.

The information indicative of the user head position can comprise information that has been obtained from a playback device. For example, a headset or earphones can comprise one or more sensors that can be configured to detect movement of the user's head and so can enable the user head position to be determined. In other examples a head tracking device could be provided that is separate to the playback apparatus.

The information indicative of a user head position can comprise information indicating an orientation of the user's head. For example, it can comprise information indicating an angle of yaw, pitch and roll. In some examples the information indicative of the user head position can also comprise information relating to the location of the user. For example, it can comprise information indicative of a user's location in a three-dimensional coordinate system such as a cartesian coordinate systems. In some examples the information indicative of the user head position can comprise information relating to both the orientation and the location. This could be used in systems that allow the user six degrees of freedom of movement.

The user head position can be measured relative to a reference point. The reference point can be a geographic orientation such as magnetic North. In other examples the reference could be the position of the rendering device, the position of the user's body, the position of a vehicle, or the position of any other suitable object.

The information indicative of a user head position can be received from the playback apparatus to the rendering apparatus. The information indicative of a user head position can be transmitted to the rendering apparatus via a wired or wireless communication link.

The information indicative of a user head position can be received at the same time, or at a different time to the one or more audio input signals.

At block 105 the method comprises processing the received one or more audio input signals to obtain a spatial audio signal based on the user head position. The processing can comprise rendering performed on the audio input signals to provide an output signal that can be used for playback. The rendering can comprise processing that generates a digital output that can be used for playback.

The rendering can comprise processing the audio input signals to obtain a spatial audio signal. The spatial audio signal comprises spatial information that can be perceived by the user when the spatial audio is played back. The spatial audio signal can provide for immersive audio experiences where the audio played back to the user is aligned with the user position.

In some examples the spatial audio signal can comprise a binaural signal. The binaural signal can be rendered for playback via earpieces or a headset or any other suitable playback device. Other types of spatial audio signal could be used in other examples of the disclosure.

The information indicative of the user head position is used to render received audio input signals. The information indicative of the user head position is used to generate the spatial audio effects that correspond to the user head position. For example, it will create spatial audio effects based on whether a user is facing towards or facing away from a sound source.

At block 107 the method comprises obtaining compensation metadata. The compensation metadata can comprise any information that can enable latency errors, or other similar errors, in the spatial audio to be corrected. The compensation metadata can comprise any information that enables a difference in the current head position of the user and the head position that has been used for the rendering of the spatial audio to be accounted for.

In some examples the compensation metadata comprises information indicating the user head position corresponding to the spatial audio signal and information indicating how the spatial audio signal should be adjusted to account for a change in the user head position. That is, the compensation metadata can indicate the user head position that has been used to render the spatial audio signal. This information can be provided as an indication of the user head position or could be provided as timing information. If the information comprises timing information then the playback apparatus could use the timing information to work out the user head position corresponding to a time period covered by the timing information.

In some examples rather than indicate the user head position on which the processing has been based in the compensation metadata the playback device can be configured to determine this based on a known delay from the rendering device. For example, if the delay in providing the processed audio signal to the playback device is known by the playback device then the playback device can refer to time stamped head position data to determine the head position on which the processing has been based.

The compensation metadata can also comprise information indicating how one or more spatial features of the spatial audio signals are to be adjusted to account for a difference in the user head position compared to the user head position corresponding to the spatial audio signal.

In some examples the compensation metadata comprises instructions to the playback apparatus to enable the adjustments to the spatial audio to be performed by the playback apparatus. The adjustments would be carried out by the playback apparatus after the audio signal has been received by the playback apparatus.

The adjustments to the spatial audio signal that are enabled by the compensation metadata typically require fewer computational resources than the rendering of the audio input signals to provide the spatial audio signal. In some examples the adjustments to the spatial audio signal enable minor corrections to be made to the spatial audio signal.

The adjustments to the spatial audio signal that are enabled by the compensation metadata can enable a lag in processing of the audio signals and/or transmission of the audio signals to be accounted for. In some examples the adjustments to the spatial audio signal that are enabled by the compensation metadata can enable an error in a predicted head position to be accounted for.

The compensation metadata can be obtained using any suitable means. In some examples the compensation metadata can be determined by the rendering apparatus. For example, the rendering apparatus can perform processing that determines the adjustments that need to be made to correct for deviations in the user head position. In other examples the compensation metadata could be determined by a different device and could be provided to the rendering apparatus to be packaged with the spatial audio signals.

At block 109 the method comprises enabling the compensation metadata to be used to adjust the spatial audio signal to account for a change in the user head position. In some examples enabling the use of the spatial metadata can comprise enabling the compensation metadata to be transmitted with the spatial audio signal for playback by a playback apparatus. The compensation metadata can be transmitted via a wired or wireless connection. The compensation metadata can be transmitted via any suitable communication network.

The compensation metadata can be transmitted with the spatial audio signal. The compensation metadata can be packaged with the spatial audio signal so that the audio signal and the compensation metadata can be transmitted together.

After the compensation metadata has been transmitted to the playback apparatus the playback apparatus can use the compensation metadata to correct for any differences between a current user head position and the head position used for the rendering of the spatial audio. The rendering apparatus does not use the compensation metadata but provides it to the playback apparatus for use by the playback apparatus.

In other examples the compensation metadata could be used by the rendering apparatus. For example, if there is a delay within the rendering device between processing the spatial audio signal and enabling the playback of the spatial audio then this could be accounted for by using the compensation metadata.

FIG. 2 shows an example method that can be performed by a playback apparatus. The playback apparatus could be any device that is configured to playback spatial audio to a user. For example, the playback apparatus could be a headset or earphones.

The playback apparatus could have fewer computational resources than the rendering apparatus. This means that the playback apparatus need not be configured for performing complex processing such as full rendering of the spatial audio signals.

At block 201 the method comprises receiving spatial audio signals and compensation metadata. The spatial audio signals and the compensation metadata can be received from the rendering apparatus that processes input audio signals to obtain the spatial audio signals.

The spatial audio signals are rendered corresponding to an indicated user head position. The spatial audio signals are rendered so that the spatial effects within the spatial audio signal are correct, or substantially correct, for the indicated user head position.

The user head position can be indicated in information that is provided to a rendering device. In some examples information indicative of a user head position can be provided to the rendering device from the playback device. In other examples the information indicative of a user head position can be provided to the rendering device from a head tracking device that is separate to the playback device. The information can be obtained from one or more sensors that can be configured to detect movement of the user's head and so can enable the user head position to be determined. The information indicative of the user head position can be provided to a rendering device so that the rendering device can use the information indicative of the user head position to render the spatial audio for that head position. The indicated user head position can therefore be a measured head position of the user.

The information indicative of the user head position could be information relating to a current position of the user's head and/or could comprise information relating to predicted future positions of a user's head.

The compensation metadata can comprise any information that can enable latency errors, or other similar errors, in the spatial audio to be corrected. The compensation metadata can comprise any information that enables a difference in the current head position of the user and the head position that has been used for the rendering of the spatial audio to be accounted for.

In some examples the compensation metadata comprises information indicating the user head position corresponding to the spatial audio signal and information indicating how the spatial audio signal should be adjusted to account for a change in the user head position. That is, the compensation metadata can indicate the user head position that has been used to render the spatial audio signal. This information can be provided as an indication of the user head position or could be provided as timing information. If the information comprises timing information then the playback apparatus could use the timing information to work out the user head position corresponding to a time period covered by the timing information.

The compensation metadata can be packaged with the spatial audio signal so that the spatial audio signal and the compensation metadata are received together.

At block 203 the method comprises determining a current user head position. The current user head position can be determined using one or more sensors that could be positioned within the playback apparatus or otherwise coupled to the playback apparatus.

The user head position that is determined at block 203 could be different to the user head position that is provided at block 201. During the time it takes for the user head position to be transmitted to the rendering apparatus, the rendering apparatus to render the spatial audio using the head positions and the spatial audio and compensation metadata to be transmitted to playback apparatus the user could have moved their head. This would mean that there could be a difference in the current user head position and the user head position for which the spatial audio has been rendered.

At block 205 the method comprises using the compensation metadata to adjust the spatial audio to the determined current head position if the current user head position is different to the user head position corresponding to the spatial audio signals. The playback apparatus can be configured to implement instructions comprised within the compensation metadata to correct for the deviations in the user head positions. The instructions can be implemented by the playback apparatus so as to correct for differences in between the current user head position and the user head position corresponding to the spatial audio signals. This therefore reduces errors in the played back spatial audio signal and provides for improved spatial audio signals.

In the above examples, the playback device receives information indicating the user head position on which the spatial audio signal is based. For example, this can be comprised within the compensation metadata. In other examples this head position could be determined by the playback device. For example, the playback device could know the delays in the audio signals received from the rendering device. The playback device could have stored data relating to previous head positions with a corresponding time stamp and could use this head position data and the known delay to determine the user head position on which the spatial audio signal is based.

FIG. 3A shows the timing of transmissions of signals and how a perceivable lag can arise in the spatial audio.

In FIG. 3A a head tracking apparatus 301 detects a user head position at t₀. The user head position can be an angle of orientation of the user's head. The user head position can comprise an angle of yaw, pitch and/or roll of the user's head. In some examples the user head position could also comprise information relating to the location of the user within a coordinate system.

The head tracking apparatus 301 can use accelerometers or any other suitable sensors to determine the user head position.

The head tracking apparatus 301 can be a separate apparatus to the playback apparatus 305. In some examples the head tracking apparatus 301 can be provided within the same device as the playback apparatus 305.

Information indicative of the user head position is then transmitted from the head tracking apparatus 301 to a rendering apparatus 303. The rendering apparatus can be a user device such as a mobile phone or any other suitable type of processing device. The information indicative of the user head position can be transmitted to the rendering apparatus 303 using any suitable communications network.

The information indicative of the user head position is received by the rendering apparatus 303 at t₁. The rendering apparatus uses the information indicative of the user head position to control spatial audio rendering.

Once the spatial audio rendering has been performed by the rendering apparatus 303 the rendering apparatus 303 can transmit the rendered spatial audio to the playback apparatus 305. The rendered spatial audio can be transmitted to the playback apparatus 305 using any suitable communications network.

The rendered spatial audio is received by the playback apparatus 305 at t₂, where it is played back to the user.

There is therefore a delay between the head position being measured and the spatial audio being played back to the user of

Δt=t₂−t₀

If the user moves their head in this time period this will result in the spatial rendering being incorrectly aligned with the head position of the user. This could result in errors that are perceivable to the user.

FIG. 3B shows the timing of transmissions of signals and how examples of the disclosure can reduce the perceivable lag in the spatial audio.

In FIG. 3B the head tracking apparatus 301 detects a user head position at t₀. The information indicative of the user head position is then transmitted from the head tracking apparatus 301 to a rendering apparatus 303 and received by the rendering apparatus 303 at t₁.

Once the spatial audio rendering has been performed by the rendering apparatus 303 the rendering apparatus 303 can transmit the rendered spatial audio to the playback apparatus 305. The rendering apparatus 303 can also obtain compensation metadata that can be transmitted to the playback apparatus 305 with the rendered spatial audio signals.

In the example of FIG. 3B the head tracking apparatus 301 also makes a second measurement of the user head position at t₂. This provides a more up to date measurement of the user head position than the measurement made at t₀. The second measurement of the user head position is also transmitted to the playback apparatus 305.

At t₃, the playback apparatus 305 receives the rendered spatial audio and the more up to date measurement of the user head position. The playback apparatus can also receive compensation metadata from the rendering apparatus 303 and can use this compensation metadata to adjust the spatial audio signal to the more up to date head position.

If there is no significant difference between the user head position measures at time t₀ and the head position measured at time t₂ then no correction or adjustment is needed and the compensation metadata does not need to be used.

However, if there is a significant difference between the user head position measures at time t₀ and the head position measured at time t₂ then the playback device 305 can implement instructions from the compensation metadata to adjust the rendering of the spatial audio signal to the more up to date head position. The adjustments that are made to the spatial audio signals could comprise controlling amplitudes of the left and right binaural signals as a function of frequency, or any other suitable adjustments.

In the example of FIG. 3B there is therefore a perceptual delay between the head position being measured and the spatial audio being played back to the user of

Δt=t₃−t₂

which is significantly smaller than the delay in the example shown in FIG. 3A.

It is to be appreciated that the examples shown in FIGS. 3A and 3B are simplified examples and that other delays could be introduced into the system that are not shown in FIGS. 3A and 3B.

FIG. 4 schematically shows a system 401 that could be used to implement examples of the disclosure. The example system 401 comprises a rendering apparatus 403 and a playback apparatus 405. The rendering apparatus 403 and playback apparatus 405 are configured to exchange information. The rendering apparatus 403 and playback apparatus 405 can exchange information using a wired or wireless communication link. Other apparatus that are not shown in FIG. 4 could also be comprised within the system 401 in other examples of the disclosure.

The rendering apparatus 403 could be configured to perform the method as shown in FIG. 1. The rendering apparatus 403 can be configured to render spatial audio to correspond to a user head position. The rendering apparatus 403 could be a smart phone, a tablet, a laptop computer or any apparatus that enable audio rendering for playback.

In the example shown in FIG. 4 the rendering apparatus 403 comprises an audio rendering module 407. It is to be appreciated that the rendering apparatus 403 could comprise additional modules and components that are not shown in FIG. 4.

The audio rendering module 407 is configured to receive audio input signals 409. The audio input signals 409 could be received from any suitable source. For example, the audio input signals 409 could be received from an audio content provider or could be retrieved from a memory of the rendering apparatus 403.

The audio rendering module 407 is also configured to receive information indicative of a user head position 411. In this example the information indicative of a user head position 411 is received from a head tracker module 413 that is comprised within the playback apparatus 405.

In other examples the head tracker module 413 could be provided in a device that is separate to the playback apparatus 405.

The audio rendering module 407 uses the audio input signal 409 and the information indicative of a user head position 411 to render spatial audio signals 415. In this example the spatial audio signals 415 comprises binaural audio. In other examples other types of spatial audio signal could be used.

The audio rendering module 407 is also configured to obtain compensation metadata 417. The compensation metadata 417 comprises information that indicates the user head position corresponding to the spatial audio signal 415. That is the compensation metadata 417 indicates the head position that has been used to render the spatial audio signal 415. The spatial audio signal 415 will be correctly, or substantially correctly, rendered for this head position.

The compensation metadata 417 also comprises information that indicates how the spatial audio signal 415 should be adjusted to account for a change in the user head position. The compensation metadata 417 comprises information that can be used by the playback apparatus 405 to correct for changes in the user head position.

The rendering apparatus 403 is configured to transmit the spatial audio signal 415 and the compensation metadata 417 to the playback apparatus 405. The spatial audio signal 415 and the compensation metadata 417 can be transmitted via any suitable wired or wireless connection. Any suitable encoding process can be used to enable the spatial audio signal 415 and the compensation metadata 417 to be transmitted. The spatial audio signal 415 and the compensation metadata 417 could be packaged together to enable the spatial audio signal 415 and the compensation metadata 417 to be transmitted within the same signal.

The playback apparatus 405 could comprise headphones, a head mounted display with audio playback capability or any other suitable type of playback apparatus 405. In the example shown in FIG. 4 the playback apparatus 405 comprises a head tracking module 413 and a compensation processing module 419. It is to be appreciated that the playback apparatus 405 could comprise additional modules and components that are not shown in FIG. 4.

The head tracking module 413 can comprise any means that can be configured to determine a user head position. The head tracking module 413 can be configured to determine an orientation of a user's head and/or a position of a user's head. The head tracking module 413 can comprise one or more accelerometers or any other suitable sensors for determining the user head position. In other examples the head tracking module 413 could be provided separately to the playback apparatus 405.

The playback apparatus 405 is configured to enable information indicative of a user head position 411 to be transmitted from the head tracking module 413 to the rendering apparatus 403. The playback apparatus can also be configured to enable the information indicative of a user head position 411 to be provided to other modules within the playback apparatus 405 such as the compensation processing module 419.

The compensation processing module 419 can be configured to correct the spatial audio signals 415 that are received by the playback apparatus 405 to account for changes in the user head position.

The compensation processing module 419 is configured to receive an input from the head tracking module 413. This can enable the compensation processing module 419 to determine an up to date user head position.

The compensation processing module 419 can be configured to use the compensation metadata 417 that is received with the spatial audio signals and use this to determine if the spatial audio signal 415 needs to be corrected and use the instructions provided within the compensation metadata 417 to make the suggested adjustments. The adjustments may be instructed if the current user head position, as determined by the head tracking module 413 differs from the user head position that was used by the audio rendering module 407 to render the spatial audio 415 by more than a threshold amount. If the difference in the user head positions is smaller than a threshold amount then the compensation processing module 419 does not need to make adjustments to the spatial audio signal 415.

The playback apparatus 405 therefore provides a corrected spatial audio output signal 421 as an output signal. The corrected spatial audio output signal 421 can be played back by an audio transducing means within the playback apparatus 405.

FIG. 5 shows an example audio rendering module 407 in more detail. The audio rendering module 407 could be provided within a rendering apparatus 403 as shown in FIG. 4 or in any other suitable apparatus or device.

The audio rendering module 407 is configured to receive audio input signals 409. In this example the audio input signal 409 is in Ambisonics form that consists of a set of spherical harmonic signals.

The audio input signal 409 can be denoted as s(m, ch), where m is the time sample index and ch is the channel index. The audio signals can be expressed in a vector form as

$${s}_{in} ( m ) = [ \begin{matrix}s ( m , 1 ) \\ s ( m , 2 ) \\ ⋮ \\ s ( m , {N}_{ch} )\end{matrix} ]$$

where N_{ch} is the number of channels. In case of a third order Ambisonic signals, N_{ch}=16.

The audio rendering module 407 is also configured to receive information indicative of a user head orientation 411. This information can be received from a head tracking device or from sensors within a playback apparatus 405.

The audio rendering module 407 is configured so that information indicative of a user head orientation 411 and the audio signals 409 are provided to a rotation matrix processing module 501. The rotation processing module 501 is configured to perform rotation of the spherical harmonic signal according to the user head position. In order to perform this rotation the rotation processing module 501 first formulates a rotation matrix R(yaw(m), pitch(m), roll(m)) according to the head orientation (yaw, pitch, roll) at time m and then applies this rotation matrix to the audio input signals 409:

sᵣₒₜ(m)=Rsᵢₙ(m)

where dependency on (yaw(m), pitch(m), roll(m)) is omitted for brevity of notation.

Any suitable method can be used to obtain the rotation matrices.

The rotation processing module 501 therefore provides rotated audio signals sᵣₒₜ(m) as an output. The rotated signals sᵣₒₜ(m) provided in this example are Ambisonic signals, in which user head orientation is already accounted for.

The rotation matrices can be processed in time intervals, for example, for every frame of 512 samples, and then interpolated linearly during the frame. The rotated audio signals sᵣₒₜ(m) are provided as an input to the forward filter bank module 503.

The forward filter bank module 503 is configured to convert the rotated audio signals sᵣₒₜ(m) to a time-frequency domain. Any suitable process can be used to convert the rotated audio signals sᵣₒₜ(m) to a time-frequency domain. For instance, the forward filter bank module 503 could use short-time Fourier transform (STFT), complex-modulated quadrature mirror filter (QMF) bank or any other suitable means.

As an example, the STFT is a procedure that can be configured so that the current and the previous audio frames are together processed with a window function and then processed with a fast Fourier transform (FFT). The result is time-frequency domain signals which are denoted as s_{rot,f}(b, n), where b is the frequency bin and n is the temporal frame index. These time-frequency rotated audio signals s_{rot,f}(b, n) are output from the forward filter bank module 503 and are provided to an Ambisonics to binaural matrix applicator module 505.

The Ambisonics to binaural matrix applicator module 505 is configured to receive the time-frequency rotated audio signals s_{rot,f}(b, n). The Ambisonics to binaural matrix applicator module 505 is also configured to receive Head-related transfer function (HRTF) data 509. In this example the HRTF data 509 comprises information that enables the Ambisonics signals to be converted to binaural signals. The HRTF data 509 could comprise Ambisonics-to-binaural decoding matrices in frequency bands.

The Ambisonics-to-binaural decoding matrices can be generated using any suitable method. The Ambisonics-to-binaural decoding matrices can be generated by any suitable apparatus. The audio rendering apparatus 403 does not need to generate the Ambisonics-to-binaural decoding matrices. These could be obtained from any suitable source.

An Ambisonics-to-binaural decoding matrix, for a frequency bin, may be obtained as follows.

First, a HRTF set is obtained, where for each frequency bin the HRTF set comprises left and right ear complex responses (amplitude and phase) for a plurality of directions. The set of directions can be a spherically evenly distributed set. However, in other examples other distributions of the directions can be used. The distributions of the directions can be selected so that all directions are represented to a roughly equivalent degree.

For each individual frequency bin, the HRTFs for different directions are organized to a matrix form:

$$H ( b ) = [ \begin{matrix}{h}_{left} ( b , 1 ) & {h}_{left} ( b , 2 ) & ⋯ & {h}_{left} ( b , {N}_{dirs} ) \\ {h}_{right} ( b , 1 ) & {h}_{right} ( b , 2 ) & ⋯ & {h}_{right} ( b , {N}_{dirs} )\end{matrix} ]$$

where h_{left}(b, d) is the complex response for left ear at bin b and direction d, and N_{dirs} is the number of directions at the data set, and correspondingly for the right ear h_{right}(b, d).

An Ambisonic panning matrix is formulated for all directions d

$$A = [ \begin{matrix}a ( 1 , 1 ) & a ( 1 , 2 ) & ⋯ & a ( 1 , {N}_{dirs} ) \\ a ( 2 , 1 ) & a ( 2 , 2 ) & & ⋮ \\ ⋮ & & ⋱ & \\ a ( {N}_{ch} , 1 ) & ⋯ & & a ( {N}_{ch} , {N}_{dirs} )\end{matrix} ]$$

where a(ch, d) is the Ambisonic response for direction d and Ambisonic component ch.

The 2×N_{ch} Ambisonics-to-binaural decoding matrix is formulated as

M(b)=H(b)A⁻¹

where the superscript −1 denotes matrix inverse, for example the Moore-Penrose pseudoinverse or a regularized pseudoinverse. Depending on the Ambisonic order, at high frequencies the HRTF matrix H(b) can comprise only HRTF amplitudes, for example, the absolute values of the complex HRTF gains. The frequency above which only amplitudes can be used may depend on the Ambisonic order. For third order, the frequency limit could, for example, be 1700 Hz.

The Ambisonics to binaural matrix applicator module 505 can therefore formulate the time frequency binaural audio signals by:

s_{bin,f}(b,n)=M(b)s_{rot,f}(b,n)

The time frequency binaural audio signals s_{bin,f}(b, n) are provided as an input to the inverse filter bank module 507.

In examples of the disclosure the Ambisonics to binaural matrix applicator module 505 also formulates a plurality of other time frequency binaural audio signals for a plurality of other user head positions. In the example shown in FIG. 5 the Rotation matrix processing module 501 has accounted for the head orientation indicated in the information indicative of the user head position 411 to obtain the rotated Ambisonic signals based on which the time frequency binaural audio signals s_{bin,f}(b, n) are subsequently obtained. In addition to this the Ambisonics to binaural matrix applicator module 505 can assume further potential changes to the user head position. For example, further rotations of the user's head could be assumed and the plurality of other time frequency binaural audio signals can be formulated for the assumed user head positions. The additional time frequency binaural audio signals can be used to form compensation metadata that could be used if the user head position has changed between the time the audio rendering module 403 renders the spatial audio signals to the time when the signals are reproduced with the playback apparatus 405.

The plurality of other time frequency binaural audio signals are formulated by

s_{binR,f}(b,n,r)=M(b)R(yaw(r),pitch(r),roll(r))s_{rot,f}(b,n)

where r is a rotation index for a set of Nᵣₒₜ rotations (r=1 . . . Nᵣₒₜ). In some examples, the rotations can comprise a set of rotations on the yaw axis only, for example

$$yaw ( r ) = - 90 ° + \frac{r - 1}{{N}_{rot} - 1} 180 ° and pitch ( r ) = roll ( r ) = 0.$$

The motivation for estimating only yaw rotations is that this is the most common axis in which a user would perform rapid head rotation. Rapid roll rotations of a user head are uncommon and thus changes in a roll direction are unlikely to be as significant as changes in yaw direction. Rapid pitch rotations could occur, however, changes in the pitch of a user's head have a lesser effect on inter-aural level differences than the yaw rotation due to the effects of head shadowing. This means that rapid pitch rotations are unlikely to cause significant latency issues within the spatial audio compared to yaw rotations.

The signals s_{binR,f}(b, n, r) and s_{bin,f}(b, n) together form the multiple orientations time-frequency binaural audio signals 511 that are provided as an output of the Ambisonics to binaural matrix applicator module 505. The multiple orientations time-frequency binaural audio signals 511 are provided to the level determining module 513.

The rotation set data 515 is also provided as an output of the Ambisonics to binaural matrix applicator module 505. This comprises information indicating the different rotations that have been used to obtain the plurality of other time frequency binaural audio signals. The rotation set data 515 is provided to a quantizer/multiplexer module 517.

The level determining module 513 is configured to determine levels for the different orientations corresponding to the signals s_{binR,f}(b, n, r) and s_{bin,f}(b, n) that form the multiple orientations time-frequency binaural audio signals 511. The level determining module 513 is configured to formulate, for a determined set of frequency bands, a set of gains for energy correction for each orientation. The frequency bands can be pre-determined, and each band k has a lowest bin b_{low}(k) and a highest bin b_{high}(k). The resolution of the frequency bands can follow a non-linear frequency resolution, such as, the Bark frequency resolution. In the example of FIG. 5 each of the modules know this pre-determined resolution. In other examples the resolution can be signalled to the relevant modules.

To determine gains for energy correction the level determining module 513 formulates band energy values

$$[ \begin{matrix}{E}_{leftR} ( k , n , r ) \\ {E}_{rightR} ( k , n , r )\end{matrix} ] = {\sum }_{{b}_{low} ( k )}^{{b}_{high} ( k )} {\vert {s}_{binR , f} ( b , n , r ) \vert}^{2} \\ [ \begin{matrix}{E}_{left} ( k , n ) \\ {E}_{right} ( k , n )\end{matrix} ] = {\sum }_{{b}_{low} ( k )}^{{b}_{high} ( k )} {\vert {s}_{bin , f} ( b , n ) \vert}^{2}$$

where the absolute and square operations denote operations performed separately for the vector elements. In this example the vector elements comprise the left and right binaural channels. The level determining module 513 then formulates correction gains for each rotation and frequency, for the current time index, by

$${g}_{left} ( k , n , r ) = \sqrt{\frac{{E}_{leftR} ( k , n , r )}{{E}_{left} ( k , n )}} \\ {g}_{right} ( k , n , r ) = \sqrt{\frac{{E}_{rightR} ( k , n , r )}{{E}_{right} ( k , n )}}$$

These gains provide binaural level change data 519. The binaural level change data 519 is provided as an output of the level determining module 513 and provided to the quantizer/multiplexer module 517.

The quantizer/multiplexer module 517 receives the information indicative of the user head position 411, the binaural level change data 519 and the rotation set data 515. The quantizer/multiplexer module 517 is configured to quantize and/or encode these signals or some of these signals to provide an output comprising compensation metadata 521. The compensation metadata therefor provides information on how the spatial audio can be adjusted for different head rotations and can be provided as an output of the audio rendering module 407.

The inverse filter bank module 507 receives the time frequency binaural audio signals s_{bin,f}(b, n). This comprises the binauralized signal corresponding to the head position indicated in the information indicative of a user head position 411. This does not comprise the binauralized signals for any of the further rotations. The inverse filter bank module 507 applies an inverse time-frequency transform. The inverse time-frequency transform can be corresponding to the forward time-frequency transform applied by the forward filter bank module 503. This provides a binaural audio signal 523 as an output of the audio rendering module 407.

The audio rendering modules 407 therefore provides two output signals, a binaural audio signal 523 and a corresponding signal comprising compensation metadata 521. The compensation metadata 521 in FIG. 5 can be the compensation metadata 417 shown in FIG. 4. Similarly, the binaural audio signal 523 in FIG. 5 can be the spatial audios 415 shown in FIG. 4.

FIG. 6 shows an example compensation processing module 419 in more detail. The compensation processing module 419 could be provided within a playback apparatus 405 as shown in FIG. 4 or in any other suitable apparatus or device.

The playback apparatus 405 is configured to receive the compensation metadata 521 from the rendering apparatus 403. The compensation metadata 521 can then be provided to the compensation processing module 419. Within the compensation processing module 419 the compensation metadata 521 is provided to a demultiplexer module 601. The demultiplexer module 601 is configured to perform demultiplexing and decoding corresponding to the multiplexing and encoding performed by the quantizer/multiplexer module 517 of the audio rendering module 407.

The demultiplexer module 601 provides data indicative of the user head orientation 603 as an output. The head orientation is the head orientation that has been used by the audio rendering module 407 to provide the binaural audio signal 523.

The demultiplexer module 601 also provides an output signal comprising rotation set data 605. This comprises information indicating the different rotations that have been used, by the audio rendering module 407, to obtain the plurality of other time frequency binaural audio signals.

The demultiplexer module 601 also provides an output signal comprising rotation binaural level data 607. The rotation binaural level data 607 comprises level change data for the different head rotations indicated in the rotation set data 605.

The data indicative of the user head orientation 603 is provided to an orientation difference determiner module 609. The orientation difference determiner module 609 is also configured to receive data indicative of an updated head orientation 611. Therefore, the difference determiner module 609 receives data indicating two head orientations. The first head orientation is the orientation for which the binaural audio signal 523 has been rendered and the second head orientation is a based on more recent measurements from a head tracking device. The second head orientation can therefore take into account movements that the user has made while the binaural audio signal 523 has been rendered and transmitted to the playback apparatus 405.

Any suitable process can be used to determine a difference in the head orientations. In some examples changes in the head orientation within the yaw axis can be accounted for. In such examples a difference between the respective head orientations can be determined by
1. Determining first order rotation matrix corresponding to first/rendered head orientation. We denote this matrix as R_{R}
2. Determining first order rotation matrix corresponding to second/updated head orientation. We denote this matrix as R_{U}
3. Determining a difference rotation matrix by R_{diff}=R_{U}R_{R}⁻¹
4. Determining the yaw difference as yaw_{diff}=a tan 2(r_{4,2}, r_{4,4}), where r_{a,b} denotes the a:th row b:th column entry of matrix R_{diff}

In the above formulas the time-dependency has been omitted for brevity of notation. The above also assumes the rotation matrices in the WYZX channel order. Other processes could be used in other examples of the disclosure.

The orientation difference determiner module 609 provides orientation difference data 613 as an output. In the example of FIG. 6 the orientation difference data is only for the changes in yaw. Other changes in position could be accounted for in other examples of the disclosure.

The orientation difference data 613 is provided as an input to a binaural compensation processing module 615. The binaural compensation processing module 615 also receives the binaural level data 607 and the rotation set data 605.

The playback apparatus 405 is configured to receive the binaural audio signal 523 from the rendering apparatus 403. The binaural audio signal 523 can then be provided to the binaural compensation processing module 615.

The binaural compensation processing module 615 is configured to use the binaural level data 607 and the rotation set data 605 and the orientation difference data 613 to correct the binaural audio signal 523 to account for changes in the head orientation.

In some examples the binaural compensation processing module 615 can be configured to monitor the rotation set data 605 to find a rotation corresponding to the difference indicated in the orientation difference data 613. As an example, the rotation set data 605 can comprise a set of yaw values yaw(r) for r=1, . . . , Nᵣₒₜ. The binaural compensation processing module 615 can then select the r for which yaw(r) is closest to yaw_{diff}. That closest index r is denoted r_{c}.

The binaural compensation processing module 615 is also configured to convert the received binaural audio signal 523 to time-frequency domain. Any suitable means can be used to convert the received binaural audio signal 523 to time-frequency domain such as a low-delay filter bank, or a STFT. If an STFT is used then the frame length can be kept short to reduce delays. These time-frequency binaural audio signals are denoted s′_{bin,f}(b, n).

If the yaw difference yaw_{diff} is non-zero or substantially non-zero then the time-frequency binaural audio signals s′_{bin,f}(b, n) are processed using the rotation binaural level data 607. In this example the rotation binaural level data 607 comprises level-correction gains g_{left}(k, n, r) and g_{right}(k, n, r). Therefore, the level-correction processing, for each frequency bin b, is

$${s}_{binC , f}^{′} ( b , n ) = [ \begin{matrix}{g}_{left} ( k , n , {r}_{c} ) & 0 \\ 0 & {g}_{right} ( k , n , {r}_{c} )\end{matrix} ] {s}_{bin , f}^{′} ( b , n )$$

where band index k is that where bin b resides. The signals s′_{binC,f}(b, n) are then converted back to time domain with an inverse time-frequency transform corresponding to the applied time-frequency transform. The result is the compensated binaural audio signal 617, which is the output of the compensation processing module 419.

In this example the compensation of levels as a function of frequency was performed using a filter bank. Other means for compensation of levels can be used in other examples such as adaptive IIR (infinite input response) filter or any other suitable means.

In some examples, the wireless transmission of the spatial audio signal 415 from the rendering apparatus 403 to the playback apparatus 405 uses an encoder/decoder operating in a time-frequency domain. In some cases, the spectral correction processing can be incorporated as part of such a decoder.

In the examples of FIGS. 5 and 6 Ambisonics has been used as the audio input signal 409. It is to be appreciated that other types of audio signal can be used in other examples of the disclosure. Also, in these examples only one type of compensation metadata was used. Other types of compensation metadata 521 can be used in other examples of the disclosure.

FIG. 7 shows another example audio rendering module 407 in more detail. The audio rendering module 407 could be provided within a rendering apparatus 403 as shown in FIG. 4 or in any other suitable apparatus or device.

The audio rendering module 407 is configured to receive audio input signals 409. In this example the audio input signal 409 is 5.1 audio input signals. Other types of loudspeaker input signals such as mono, stereo, or 7.1+4 or any other suitable type of audio input signal 409 could be used in other examples of the disclosure.

In the example of FIG. 7 the audio input signal 409 is provided to the forward filter bank module 701. The forward filter bank module 701 can be configured to convert the audio input signal 409 to the time-frequency domain to provide time-frequency domain audio signals 703.

The time-frequency domain audio signals 703 are provided from the forward filter bank module 701 to a binauralizer module 705. The binauralizer module 705 is configured to render the time-frequency domain audio signals 703 to time-frequency domain binaural audio signals 707. Any suitable process can be used to render the time-frequency domain audio signals 703 to time-frequency domain binaural audio signals 707.

The rendering of the time-frequency domain binaural audio signals 707 can be based on the positions of loudspeakers of the audio input signals 409, information indicative of a user head position 411 and HRTF data 509. In some examples data indicative of the loudspeaker positions 709 could be received by the binauralizer module 705. In other examples default loudspeaker positions could be used.

The time-frequency domain binaural audio signals 707 are provided to an inverse filter bank module 711. The inverse filter bank module 711 applies an inverse time-frequency transform. The inverse time-frequency transform can be corresponding to the forward transform applied by the forward filter bank module 701. This provides a binaural audio signal 523 as an output of the audio rendering module 407.

In addition to the time-frequency domain binaural audio signals 707 the binauralizer module 705 also renders a plurality of additional time-frequency domain binaural audio signals 713 with different additional rotations yaw(r). The binauralizer module 705 provides the plurality of additional time-frequency domain binaural audio signals 713 to the level determining module 715. The time-frequency domain binaural audio signals 707 can be provided to the level determining module 715 with the additional time-frequency domain binaural audio signals 713. The level determining module 715 is configured to determine levels for the different orientations and frequencies corresponding to the plurality of additional time-frequency domain binaural audio signals 713.

The level determining module 715 can be configured, as described in relation to FIG. 5, to provide binaural level change data 717 as an output. The binaural level change data 717 can comprise correction gains for each rotation and frequency.

The quantizer/multiplexer module 719 receives the information indicative of the user head position 411, the binaural level change data 717 and rotation set data 721. The quantizer/multiplexer module 719 is configured to quantize and/or encode these signals or some of these signals to provide an output comprising compensation metadata 521. The compensation metadata 521 therefor provides information on how the spatial audio can be adjusted for different head rotations and can be provided as an output of the audio rendering module 407. The compensation metadata 521 can then be transmitted to a playback apparatus 405 where it can be used as shown in FIG. 6 and described above.

FIG. 8 shows another example audio rendering module 407 in more detail. The audio rendering module 407 could be provided within a rendering apparatus 403 as shown in FIG. 4 or in any other suitable apparatus or device.

The audio rendering module 407 is configured to receive audio input signals 409. In this example the audio input signal 409 is parametric audio. The parametric audio comprises two input signals. The first input signal is a transport audio signal 801 and the second input signal is a spatial metadata signal 803 that comprises spatial information such as directions and direct-to-total energy ratios in frequency bands.

In the example of FIG. 8 the transport audio signal 801 is provided to the forward filter bank module 805. The forward filter bank module 805 can be configured to convert the transport audio signal 801 to the time-frequency domain to provide time-frequency domain audio signals 807.

The time-frequency domain audio signals 807 are provided from the forward filter bank module 805 to a binauralizer module 809. The binauralizer module 809 is configured to render the time-frequency domain audio signals 807 to time-frequency domain binaural audio signals 811. Any suitable process can be used to render the time-frequency domain audio signals 807 to time-frequency domain binaural audio signals 811.

The binauralizer module 809 also receives the spatial metadata signal 803. The rendering of the time-frequency domain binaural audio signals 811 can be based on the spatial metadata signal 803 and also information indicative of a user head position 411 and HRTF data 509.

The time-frequency domain binaural audio signals 811 are provided to an inverse filter bank module 813. The inverse filter bank module 813 applies an inverse time-frequency transform. The inverse time-frequency transform can be corresponding to the forward transform applied by the forward filter bank module 805. This provides a binaural audio signal 523 as an output of the audio rendering module 407.

In the example shown in FIG. 8 the level determining module 815 is configured to determine the binaural level change data 817. The level determining module 815 uses the spatial metadata signal 803 to determine the binaural level change data 817. The level determining module 815 can also be configured to determine rotation set data. Any suitable method, such as the methods described above, can be used to determine the rotation set data.

For example, the spatial metadata signal 803 can comprise an azimuth direction parameter azi′(k, n), an elevation direction parameter ele′(k, n), and a direct-to-total energy ratio parameter ratio(k, n). The azi′(k, n) and ele′(k, n) values are first processed to rotated azi(k, n) and ele(k, n) values according to the current head orientation as indicated by the information indicative of the user head position 411. This rotation of the direction metadata can be performed by the level determining module 815. In other examples the binauralizer module 809 can perform the rotation of the direction metadata and provide the rotated values to the level determining module 815.

The HRTFs comprise the complex gains for the left and right channels. The HRTFs for the direction azi, ele for frequency bin b are denoted

HRTF_{left}(b,azi,ele)

HRTF_{right}(b,azi,ele)

where dependency (k, n) of azi, ele has been omitted for brevity of notation.

The level determining module 815 then determines gains for set of yaw rotations r

$${g}_{left} ( k , n , r ) = \sqrt{\frac{\frac{ratio ( k , n )}{{b}_{high} ( k ) - {b}_{low} ( k ) + 1} {\sum }_{{b}_{low} ( k )}^{{b}_{high} ( k )} {\vert {HRTF}_{left} ( b , azi - yaw ( r ) , ele ) \vert}^{2} + ( 1 - ratio ( k , n ) )}{\frac{ratio ( k , n )}{{b}_{high} ( k ) - {b}_{low} ( k ) + 1} {\sum }_{{b}_{low} ( k )}^{{b}_{high} ( k )} {\vert {HRTF}_{left} ( b , azi , ele ) \vert}^{2} + ( 1 - ratio ( k , n ) )}}$$

and equivalently to the right channel to obtain g_{right}(k, n, r). In the above formula, it has been assumed that the HRTF data set has been diffuse-field equalized so that its mean energy across all directions is 1.

The level determining module 815 therefore provides as an output binaural level change data 817 where the binaural level change data 817 comprises gains g_{left}(k, n, r) and g_{right}(k, n, r). The binaural level change data 817 is provided to the quantizer/multiplexer module 819.

The quantizer/multiplexer module 819 receives the information indicative of the user head position 411, the binaural level change data 817 and rotation set data 821. The quantizer/multiplexer module 819 is configured to quantize and/or encode these signals or some of these signals to provide an output comprising compensation metadata 521. The compensation metadata 521 therefor provides information on how the spatial audio can be adjusted for different head rotations and can be provided as an output of the audio rendering module 407. The compensation metadata 521 can then be transmitted to a playback apparatus 405 where it can be used as shown in FIG. 6 and described above.

The example audio rendering module 407 of FIG. 8 could be used for other types of audio input signals 409 such as Ambisonics, 5.1 objects or any other suitable type of audio. In such examples the spatial metadata can be determined from the input audio signals using any suitable processes. In such examples the binauralization can be performed as shown in FIG. 5 or FIG. 7, but the binaural level change data 817 can be determined as shown in FIG. 8.

In the examples of FIGS. 5 to 8 the compensation metadata 521 comprises binaural level change data. Other types of compensation metadata can be used in other examples of the disclosure. FIG. 9 shows another example audio rendering module 407 that uses a different type of compensation metadata 521. The audio rendering module 407 could be provided within a rendering apparatus 403 as shown in FIG. 4 or in any other suitable apparatus or device.

The audio rendering module 407 is configured to receive audio input signals 409. In the example of FIG. 9 the audio input signal 409 is parametric audio. The parametric audio comprises two input signals. The first input signal is a transport audio signal 901 and the second input signal is a spatial metadata signal 903 that comprises spatial information such as directions and direct-to-total energy ratios in frequency bands. Other types of audio input can be used in other examples of the disclosure provided that the spatial metadata can be derived from the input audio signal 409.

In the example of FIG. 9 the transport audio signal 901 is provided to the forward filter bank module 905. The forward filter bank module 905 can be configured to convert the transport audio signal 901 to the time-frequency domain to provide time-frequency domain audio signals 907.

The time-frequency domain audio signals 907 are provided from the forward filter bank module 905 to a binauralizer module 909. The binauralizer module 909 is configured to render the time-frequency domain audio signals 907 to time-frequency domain binaural audio signals 911. Any suitable process can be used to render the time-frequency domain audio signals 907 to time-frequency domain binaural audio signals 911.

The binauralizer module 909 also receives the spatial metadata signal 903. The rendering of the time-frequency domain binaural audio signals 911 can be based on the spatial metadata signal 903 and also information indicative of a user head position 411 and HRTF data 509.

The time-frequency domain binaural audio signals 911 are provided to an inverse filter bank module 913. The inverse filter bank module 913 applies an inverse time-frequency transform. The inverse time-frequency transform can be corresponding to the forward transform applied by the forward filter bank module 905. This provides a binaural audio signal 523 as an output of the audio rendering module 407.

In the example shown in FIG. 9 the audio rendering modules 407 does not comprise a level determining module. Instead the spatial metadata 903 and the information indicative of the user head position 411 are provided directly to a quantizer/multiplexer module 915. The quantizer/multiplexer module 915 therefore quantizes and multiplexes the spatial metadata 903 and the information indicative of the user head position 411 to provide the compensation metadata 521. This compensation metadata 521 is provided as an output of the audio rendering module 407 along with the binaural audio 523.

FIG. 10 shows an example compensation processing module 419 corresponding to the audio rendering module 407 shown in FIG. 9. The compensation processing module 419 could be provided within a playback apparatus 405 as shown in FIG. 4 or in any other suitable apparatus or device. The compensation processing module 419 can be configured to process the binaural audio signals 523 using the compensation metadata 521 comprising the spatial metadata 903 and the information indicative of the user head position 411.

The playback apparatus 405 receives the binaural audio signal 523 and the compensation metadata 521. The compensation metadata 521 is provided to a demultiplexer module 1001. The demultiplexer module 1001 is configured to perform demultiplexing and decoding corresponding to the multiplexing and encoding performed by the quantizer/multiplexer module 917 of the corresponding audio rendering module 407.

The demultiplexer module 1001 provides data indicative of the user head orientation 1003 as an output. The head orientation is the head orientation that has been used by the audio rendering module 407 to provide the binaural audio signal 523.

The demultiplexer module 1001 also provides the spatial metadata 1005 as an output signal.

The spatial metadata 1005 and the data indicative of the user head orientation 1003 are provided to a level data determining module 1007. The level data determining module 1007 is configured to determine rotational binaural level data. The level data determining module 1007 is configured to receive data indicative of an updated head orientation 1009. The level data determining module 1007 compares the data indicative of an updated head orientation 1009 and the original data indicative of the user head orientation 1003 to determine any differences between the original head position and an updated head position.

The level data determining module 1007 then determines the rotational binaural level data 1011 for the difference between the updated head orientation and the original head orientation. Any suitable process can be used to determine the rotational binaural level data 1011. In some examples the process could be similar to the process used by the level determining module 815 shown in FIG. 8 and described above. The rotational binaural level data 1011 in this example therefore only comprises data relating to the correct orientation. In the example shown in FIG. 10 the level data determining module 1007 also receives HRTF data 509 and uses this when determining the binaural level data 1011.

The rotational binaural level data 1011 is provided to a binaural compensation processing module 1013. The binaural compensation processing module 1013 is configured to use the rotational binaural level data 1011 to correct the binaural audio signal 523 to account for changes in the head orientation. The result is the compensated binaural audio signal 1015, which is the output of the compensation processing module 419.

FIG. 11 shows a system 1101 according to examples of the disclosure. The system comprises a rendering apparatus 403 and playback apparatus 405. In this example the rendering apparatus 403 is a mobile device 1103 and the playback apparatus 405 is a wireless headset 1105. Other types of rendering apparatus 403 and playback apparatus 405 could be used in other examples of the disclosure.

In the example of FIG. 11 the mobile device 1103 and the wireless headset 1105 are configured to communicate wirelessly with each other. The mobile device 1103 and the wireless headset can be connected via a wireless communication network 1107. The mobile device 1103 and the wireless headset 1105 can communicate using Bluetooth or any other suitable wireless communication protocol.

The mobile device 1103 comprises a processor 1111, a memory 1113, a receiver 1115 and a transmitter 1117. It is to be appreciated that the mobile device 1103 can also comprise additional components not shown in FIG. 11. The processor 1111 and memory 1113 can provide a controller as shown in FIG. 12 and described below. The processor 1111 can be configured to enable spatial rendering of an audio input signal 409. The processor 1111 can also be configured to determine compensation metadata for the spatial audio signal.

The receiver 1115 can comprise any means that can be configured to receive input signals from the wireless headset 1105. The receiver 1115 is coupled to the processor 1111 so that information indicative of the user head position 411, and any other information that is received from the wireless headset 1105, can be provided to the processor 1111.

The transmitter 1117 can comprise any means that can be configured to transmit output signals to the wireless headset 1105. The transmitter 1117 is coupled to the processor 1111 so that the spatial audio signals and the compensation metadata can be provided to the wireless headset 1105. In the example of FIG. 11 the spatial audio signal and the compensation metadata are transmitted together in a single signal 1119.

The wireless headset 1105 also comprises a processor 1121, a memory 1123, a receiver 1125, a transmitter 1127 one or more sensors 1131 and one or more audio amplifiers 1129. It is to be appreciated that the wireless headset 1105 can also comprise additional components not shown in FIG. 11. The processor 1121 and memory 1123 can form a controller as shown in FIG. 12 and described below. The processor 1121 can be configured to correct the received spatial audio signal using the compensation metadata received in the signal 1119 and provide the corrected spatial audio to the audio amplifiers 1129 for playback. In the example of FIG. 11 the processor 1121 is configured to provide a first signal 1133 comprising left headphone channel audio and a second signal 1135 comprising right headphone channel audio.

The sensors 1131 can comprise any means that can be configured to enable tracking of the user head position. In some examples the sensors 1131 can be configured to determine an orientation of the user's head. In some examples the sensors 1131 can be configured to determine a location of the user in addition to, or instead of, the rotation of their head.

The sensors 1131 are configured to provide information indicative of the user head position 411 to the transmitter 1127. The transmitter 1127 can comprise any means that can be configured to transmit output signals to the mobile device 1103.

The sensors 1131 are also configured to provide information indicative of the user head position 411 to the processor 1121 within the wireless head set 1105 to enable a current user head position to be used to correct the spatial audio signals received from the mobile device 1103.

The receiver 1125 can comprise any means that can be configured to receive input signals from the mobile device 1103. The receiver 1125 is coupled to the processor 1121 so that information received from the mobile device 1103 can be provided to the processor 1121. In the example shown in FIG. 11 the receiver 1125 receives a signal 1119 comprising the spatial audio signal and the compensation metadata.

The wireless headset 1105 is therefore configured to use compensation metadata, that is provided by the mobile device 1103 to correct the spatial audio signals provided by the mobile device 1103. This corrects for latency issues or other delays in the spatial audio signals.

FIG. 12 schematically illustrates a controller 1201 according to examples of the disclosure. The controller 1201 illustrated in FIG. 12 can be a chip or a chip-set. In some examples the controller 1201 can be provided within mobile device 1103 or a wireless headset 1105 as shown in FIG. 11. In other examples the controller 1201 could be provided in any suitable rendering apparatus 403 or playback apparatus 405.

In the example of FIG. 12 the controller 1201 can be implemented as controller circuitry. In some examples the controller 1201 can be implemented in hardware alone, have certain aspects in software including firmware alone or can be a combination of hardware and software (including firmware).

As illustrated in FIG. 12 the controller 1201 can be implemented using instructions that enable hardware functionality, for example, by using executable instructions of a computer program 1209 in a general-purpose or special-purpose processor 1205 that can be stored on a computer readable storage medium (disk, memory etc.) to be executed by such a processor 1205.

The processor 1205 is configured to read from and write to the memory 1207. The processor 1205 can also comprise an output interface via which data and/or commands are output by the processor 1205 and an input interface via which data and/or commands are input to the processor 1205.

The memory 1207 is configured to store a computer program 1209 comprising computer program instructions (computer program code 1211) that controls the operation of the controller 1201 when loaded into the processor 1205. The computer program instructions, of the computer program 1209, provide the logic and routines that enables the controller 1201 of a rendering apparatus 403 to perform the methods illustrated in FIG. 1 and the controller 1201 of a playback apparatus 405 to perform the methods illustrated in FIG. 2. The processor 1205 by reading the memory 1207 is able to load and execute the computer program 1209.

When the controller 1201 is provided within a rendering apparatus 403 the controller 1201 therefore comprises: at least one processor 1205; and at least one memory 1207 including computer program code 1211, the at least one memory 1207 and the computer program code 1211 configured to, with the at least one processor 1205, cause the controller 1201 at least to perform:
receiving 101 one or more audio input signals 409;
receiving 103 information indicative of a user head position 411;
processing 105 the received one or more audio input signals to obtain a spatial audio signal 523 based on the user head position;
obtaining 107 compensation metadata 521 wherein the compensation metadata 521 comprises information indicating how the spatial audio signal should be adjusted to account for a change in the user head position; and
enabling 109 the compensation metadata 521 to be used to adjust the spatial audio signal to account for a change in the user head position.

When the controller 1201 is provided within a playback apparatus 405 the controller 1201 therefore comprises: at least one processor 1205; and at least one memory 1207 including computer program code 1211, the at least one memory 1207 and the computer program code 1211 configured to, with the at least one processor 1205, cause the controller 1201 at least to perform:
receiving 201 spatial audio signals 523 and compensation metadata 521 wherein the spatial audio signals 523 are processed based on an indicated user head position and the compensation metadata 521 comprises information indicating how the spatial audio signal should be adjusted to account for a change in the user head position;
determining 203 a current user head position; and
using 205 the compensation metadata 521 to adjust the spatial audio to the determined current head position if the current user head position is different to the user head position on which the spatial audio signals are based.

As illustrated in FIG. 12 the computer program 1209 can arrive at the controller 1201 via any suitable delivery mechanism 1213. The delivery mechanism 1213 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 1209. The delivery mechanism can be a signal configured to reliably transfer the computer program 1209. The controller 1201 can propagate or transmit the computer program 1209 as a computer data signal. In some examples the computer program 1209 can be transmitted to the controller 1201 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 1209 comprises computer program instructions for causing a controller apparatus 1201 within a rendering apparatus 403 to perform at least the following:
receiving 101 one or more audio input signals 409;
receiving 103 information indicative of a user head position 411;
processing 105 the received one or more audio input signals to obtain a spatial audio signal 523 based on the user head position;
obtaining 107 compensation metadata 521 wherein the compensation metadata 521 comprises information indicating how the spatial audio signal should be adjusted to account for a change in the user head position; and
enabling 109 the compensation metadata 521 to be used to adjust the spatial audio signal to account for a change in the user head position.

The computer program 1209 comprises computer program instructions for causing a controller apparatus 1201 within a rendering apparatus 403 to perform at least the following:
receiving 201 spatial audio signals 523 and compensation metadata 521 wherein the spatial audio signals 523 are processed based on an indicated user head position and the compensation metadata 521 comprises information indicating the user head position on which the spatial audio signal is based and information indicating how the spatial audio signal should be adjusted to account for a change in the user head position;
determining 203 a current user head position; and
using 205 the compensation metadata 521 to adjust the spatial audio to the determined current head position if the current user head position is different to the user head position on which the spatial audio signals are based.

The computer program instructions can be comprised in a computer program 1209, a non-transitory computer readable medium, a computer program product, a machine readable medium. In some but not necessarily all examples, the computer program instructions can be distributed over more than one computer program 1209.

Although the memory 1207 is illustrated as a single component/circuitry it can be implemented as one or more separate components/circuitry some or all of which can be integrated/removable and/or can provide permanent/semi-permanent/dynamic/cached storage.

Although the processor 1205 is illustrated as a single component/circuitry it can be implemented as one or more separate components/circuitry some or all of which can be integrated/removable. The processor 1205 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software can not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in FIGS. 1 and 2 can represent steps in a method and/or sections of code in the computer program 1209. The illustration of a particular order to the blocks does not necessarily imply that there is a required or preferred order for the blocks and the order and arrangement of the blocks can be varied. Furthermore, it can be possible for some blocks to be omitted.

In the examples given above the compensation metadata 521 comprises information indicative the head position for which the spatial audio signal 523 has been rendered. In other examples the playback apparatus 405 could track the latency for the spatial audio signals 523. That is the playback apparatus 405 could determine the delay between the sending of the information indicative of the user head position and the receipt of the rendered spatial audio signals 523. The playback device 405 could then determine the head orientation that was used to render the spatial audio signal 523 so that this information does not need to be transmitted back to the playback apparatus 405.

In some examples the sensors 1131 within the playback apparatus 405 could add a timestamp to the information indicative of the user head position 411. The audio rendering apparatus 403 can then provide the timestamp and the spatial audio signal 523 to the playback apparatus 405. The playback apparatus 405 can then use this timestamp to determine the latency for the spatial audio signals 523 and to determine the head orientation that was used to render the spatial audio signal 523.

In the examples described above the compensation metadata 521 is determined and applied for yaw rotations. The same or similar means of determining and applying compensation metadata 521 could be used for head orientations comprising any combination of yaw, pitch and roll.

In the examples described above the compensation metadata 521 is only obtained for changes in orientation of the user's head. This can be useful in systems that allow for tracking with three degrees of freedom. Examples of the disclosure could also be used in systems that allow for tracking with six degrees of freedom. In such examples the translation of the user can also be tracked. In these examples the compensation metadata 521 would be configured to take into account possible translational movement. In these cases the compensation metadata 521 could comprise the level correction data for different orientations and also for different translations available. In examples where the compensation metadata comprise spatial metadata the spatial metadata could comprise distances as well as directions and ratios.

The above described examples describe that the playback apparatus 405 can used the compensation metadata 521 to apply amplitude corrections to the spatial audio signals 523. In other examples temporal or phase corrections can be applied instead of, or in addition to, the amplitude corrections. In such examples the compensation metadata 521 would comprise temporal adjustment factors that could be provided in frequency bands. The temporal adjustment factors could comprise binaural time change data and/or phase change data and/or any other suitable data. These temporal adjustment factors would then be used by the playback apparatus 405 to adjust the spatial audio signals 523. In examples where the compensation metadata 521 comprises spatial metadata the playback apparatus 405 could determine the temporal adjustment factors based on the directions and the ratios within the spatial metadata. The temporal adjustment factors could then be applied on the binaural signals. In examples where the compensation metadata 521 comprises the level change data the gains for left and right ears for different rotations could be complex-valued, to include the phase corrections.

In some examples the playback apparatus 405 or the head tracking apparatus could be configured to predict a future head position. The spatial audio could then be rendered to the predicted future head position. In some examples this could result in errors in the rendered spatial audio. For example, if the user does not move their head as predicted. Examples of the disclosure could also be used to correct these errors. This could enable more speculative predictions to be made which can provide for an improved spatial audio experience for the user.

FIG. 13 shows spectrograms of example processing outputs for a situation in which a rendering apparatus 403 within a system 1101 receives a third-order Ambisonic signal and renders a binaural output. The input is pink noise directly at front direction. At 1 second, the user starts to rotate head fast to the left until 90 degrees yaw is reached. The top row 1301 of the figure shows the output if there is no latency at the system.

The second row 1303 shows a situation where, after rendering of the spatial audio signal, there is a 200 milliseconds latency until the sound is reproduced to the user. It is clearly seen that the inter-aural levels lag with respect to the no-latency version. This causes a “rubber-band” spatialization artefact.

The third row 1305 shows that the binaural audio signal spectrum is corrected at the listening device as in the present disclosure. This clearly mitigates the negative effect of the 200 milliseconds latency.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus for rendering, comprising:
at least one processor; and
at least one non-transitory memory storing instructions that, when executed with the at least one processor, cause the apparatus at least to:
receive one or more audio input signals;
receive information indicative of a user head position;
process the received one or more audio input signals to obtain a spatial audio signal based on the user head position;
obtain compensation metadata wherein the compensation metadata comprises information indicating how the spatial audio signal is adjusted to account for a change in the user head position; and
enable the compensation metadata to be used to adjust the spatial audio signal to account for a change in the user head position.

2. An apparatus as claimed in claim 1, wherein the compensation metadata comprises information indicating the user head position on which the spatial audio signal is based.

3. An apparatus as claimed in claim 1, wherein the instructions, when executed with the at least one processor, cause the apparatus to enable the compensation metadata to be transmitted with the spatial audio signal for playback with a playback apparatus.

4. An apparatus as claimed in claim 1, wherein the spatial audio signal comprises a binaural signal.

5. An apparatus as claimed in claim 1, wherein the compensation metadata comprises information indicating how one or more spatial features of the spatial audio signals are to be adjusted to account for a difference in the user head position compared to the user head position on which the spatial audio signal is based.

6. An apparatus as claimed in claim 1, wherein the compensation metadata comprises instructions to a playback apparatus that, when executed with the at least one processor, cause the apparatus to enable the adjustments to the spatial audio to be performed with the playback apparatus.

7. An apparatus as claimed in claim 1, wherein the adjustments to the spatial audio signal that are enabled with the compensation metadata require fewer computational resources than the processing of the audio input signals to provide the spatial audio signal.

8. An apparatus as claimed in claim 1, wherein the instructions, when executed with the at least one processor, enable a lag in processing of at least one of the audio signals or transmission of the audio signals to be accounted for.

9. An apparatus as claimed in claim 1, wherein the instructions, when executed with the at least one processor, enable at least one of an error in a predicted head position to be accounted for or minor corrections to be made to the spatial audio signal.

10. A method, comprising:
receiving one or more audio input signals;
receiving information indicative of a user head position;
processing the received one or more audio input signals to obtain a spatial audio signal based on the user head position;
obtaining compensation metadata wherein the compensation metadata comprises information indicating how the spatial audio signal is adjusted to account for a change in the user head position; and
enabling the compensation metadata to be used to adjust the spatial audio signal to account for a change in the user head position.

11. (canceled)

12. An apparatus for playback, comprising:
at least one processor; and
at least one non-transitory memory storing instructions that, when executed with the at least one processor, cause the apparatus at least to:
receive spatial audio signals and compensation metadata wherein the spatial audio signals are processed based on an indicated user head position and the compensation metadata comprises information indicating how the spatial audio signal is adjusted to account for a change in the user head position;
determine a current user head position; and
use the compensation metadata to adjust the spatial audio to the determined current head position if the current user head position is different to the user head position on which the spatial audio signals are based.

13. An apparatus as claimed in claim 12, wherein the compensation metadata comprises information indicating the user head position on which the spatial audio signal is based.

14. An apparatus as claimed in claim 12, wherein the spatial audio signal comprises a binaural signal.

15. An apparatus as claimed in claim 12, wherein the instructions, when executed with the at least one processor, obtain the spatial audio signal from a rendering apparatus configured to process audio input signals to obtain the spatial audio signal.

16. An apparatus as claimed in claim 15, comprising one or more sensors configured to determine the user head position.

17. An apparatus as claimed in claim 12, wherein the instructions, when executed with the at least one processor, cause the apparatus to provide information indicative of a user head position to a rendering device.

18. An apparatus as claimed in claim 12, wherein the user head position comprises an angular orientation of at least one of the user's head or a location of the user.

19. A method comprising:
receiving spatial audio signals and compensation metadata wherein the spatial audio signals are processed based on an indicated user head position and the compensation metadata comprises information indicating how the spatial audio signal should be adjusted to account for a change in the user head position;
determining a current user head position; and
using the compensation metadata to adjust the spatial audio to the determined current head position if the current user head position is different to the user head position on which the spatial audio signals are based.

20-22. (canceled)

23. A method as claimed in claim 19, wherein the compensation metadata comprises information indicating the user head position on which the spatial audio signal is based.

24. A method as claimed in claim 19, providing information indicative of a user head position to a rendering device.

25. A non-transitory program storage device readable with an apparatus, tangibly embodying a program of instructions executable with the apparatus for performing the method of claim 10.

26. A non-transitory program storage device readable with an apparatus, tangibly embodying a program of instructions executable with the apparatus for performing the method of claim 19.
